(19) United States
(12) Patent Application Publication
(10) Pub. No.: US 2014/0266665 A1
(43) Pub. Date: Sep. 18, 2014

(54) Vehicle directional indicator

(71) Applicant: Alexa Lea Haushalter, Bellefontaine, OH (US)

(72) Inventor: Alexa Lea Haushalter, Bellefontaine, OH (US)

(21) Appl. No.: 13/815,679

(22) Filed: Mar. 14, 2013

(51) Int. Cl. B60Q 1/50; B60Q 1/34

(52) U.S. Cl. CPC B60Q 1/50; B60Q 1/343
USPC 340/464

(57) ABSTRACT

A vehicle directional indicator is provided for enhancing the safety and knowledge of all persons using roadways, including drivers, pedestrians, and bikers. Depending on the position applied to the directional indicator means by a driver, power can be sent to the left turn signal light or the right turn signal light or the straight ahead signal light. These signal lights include indicator lights on the dashboard, as well as front and rear exterior indicator lights. The straight ahead directional indication is particularly useful at an intersection, where multiple drivers are weighing the directional indicators of the other drivers at the intersection, assured clear distances, oncoming traffic and multiple other traffic patterns, to provide the safest and most timely continued travel.

### FIELD OF THE INVENTION

This invention relates generally to vehicle directional indicator signals, and more particularly, to a vehicle directional indicator signal that indicates a straight ahead direction incorporated into the left and right turn directional signals, to indicate a straight ahead directional intention of a driver.

### BACKGROUND OF THE INVENTION

In automobiles now in use, a turn signal switch is installed within easy reach of the driver of the vehicle, on or around the steering wheel. When a driver intends to turn right or left, the driver flips the turn signal switch, activating an exterior indicator light in the front and rear of the vehicle. This alerts both oncoming drivers and trailing drivers of the intention of the driver. Turn signals warn other drivers of impending moves to minimize hazards and abrupt actions.

The intention of the driver is important for a variety of reasons, including to allow traffic to flow effectively, and, more importantly, to allow traffic to flow safely. Failing to signal, or ambiguity in signaling, may be the cause of accidents, and can be a source of “road rage” as well. Consequently, it is quite important for drivers to use directional signals to indicate intentions.

When drivers approach a two-way or four-way stop, drivers will typically pay attention to the exterior turn signal indicators of the other vehicles at the intersection. If two facing vehicles are both turning left, or both turning right, the two facing drivers can often leave the intersection simultaneously, keeping the flow of traffic constant.

Confusion as to the intentions of other drivers at an intersection can slow traffic and can even result in accidents. Confusion often occurs at such intersections when a driver does not have any turn signal indicator on at all. The other drivers are left to wonder if the non-indicator driver is really going straight ahead, or if the non-indicator driver simply forgot to activate his or her turn signal. At a busy intersection, this confusion can create safety hazards and undesirable traffic flow problems.

Therefore, among the purposes of this invention is to improve the safety of vehicle travel. It is a further purpose of the present invention to provide a directional signal indicator for a vehicle. It is a particular purpose of this invention to provide such a directional signal that indicates not only a left turn or a right turn, but also a straight ahead directional indicator.

### SUMMARY OF THE INVENTION

These purposes are achieved by the vehicle directional signal system and method according to the present invention, wherein a vehicle directional signal indicates a left turn intention of a driver, a right turn intention of a driver, and a straight ahead directional intention of a driver. The straight ahead directional indication is particularly useful at an intersection, where multiple drivers are weighing the directional indicators of the other drivers at an intersection, assured clear distances, oncoming traffic and multiple other traffic patterns, to make the safest and most timely continued travel for themselves.

In accordance with one embodiment of the present invention, a turn signal circuit gets power when an ignition is keyed on. The power goes through a fuse panel or power source into a thermal flasher. From there, it continues to a directional indicator means typically associated with the steering column. Depending on the position applied to the directional indicator means, the power either stops in the switch, or gets sent to the left turn signal light or the right turn signal light or the straight ahead signal light. These signal lights include indicator lights on the dashboard, as well as front and rear exterior indicator lights. Power flows through the filament of the lights and then is grounded.

The straight ahead directional signal is activated by the driver, and can be retrofitted or added to the existing left and right turn signal indicators. The straight ahead directional indicator light is located on the front and rear of a vehicle in conjunction with turn signal lights. Alternatively, the straight ahead directional indicator signal could be a completely separate switch or lever, operating similarly to the left and right turn signal switches or levers. The straight ahead directional indicator light comprises an ambient light source visible during day light and night hours.

The primary advantage provided by the present invention is to indicate to other drivers, particularly when stopped at an intersection, the stated intention of a driver to either turn or to continue straight. Another object of the present invention is to provide an additional signal indicator for a vehicle, which can warn other motorists of the intent of the driver. Yet another object of the present invention is to provide a safer means of vehicle travel, and help prevent motor vehicle accidents.

Other objects and advantages of the invention will be apparent from the following description, the accompanying drawings and the appended claims, to which reference may be had for a full understanding of the nature of the present invention.

### BRIEF DESCRIPTION OF THE DRAWINGS

In the Drawings:

FIG. 1 illustrates a schematic diagram of a turn signal indicator system according to one embodiment of the present invention;

FIG. 2 illustrates a steering column view of a vehicle;

FIGS. 3A and 3B illustrate front and back views, respectively, of a vehicle, to illustrate the present invention;

FIG. 4 illustrates the directional options for multiple vehicles at an intersection, for purposes of description in detailing advantages of the present invention; and

FIG. 5 is a flow chart illustrating the method of activating directional signal indicators in accordance with an embodiment of the present invention.

### DESCRIPTION OF THE PREFERRED EMBODIMENT

Directional indicators, or turn signals, in vehicles work by activating a lever or switch means in a vehicle 10, such as is illustrated in FIGS. 3A and 3B. The directional intentions of a driver are indicated at the front and back of the vehicle 10 exterior, at light sources 12 and 14, respectively. As illustrated in the directional indicator circuit diagram 16 of FIG. 1, a directional signal is powered up via a power source 18 when the vehicle ignition 20 is turned on. The power source 18 can be any suitable power source, such as a grounded battery power source, a fuse panel, or a junction box, sufficient to transfer power. The power travels from the power source 18 into the thermal flasher 22 to the steering column 24 of the vehicle 10. From here, in accordance with the present invention, the power either stops in the directional indicator switch means 26, or continues to the directional indicator lights 28, 30 and 32, as well as to indicator lights 44 on the vehicle dashboard, and flashes directional indicators at light sources 12 and 14 on the front and rear of the vehicle 10.

Continuing with FIG. 1 and referring also to FIG. 2, an activation means, or turn signal lever 34, in the vehicle 10 is multi-positional to allow indication of the directional intention of the driver. The signal lever 34 is typically located proximate to the steering column 24 and steering wheel 42, and is powered by the battery 18 and actuated by the driver to signal his directional intentions. For example, continuing with FIG. 1 and referring also to FIGS. 3A and 3B, pushing up on the lever 34 as illustrated by position 36 will cause the right-turn signal 28 to flash; pushing down on the lever 34 as illustrated by position 38 will cause the left turn signal 30 to flash; and pushing inward or forward on the lever 34 as illustrated by position 40 will cause the straight ahead directional indicator light 32 to flash.

In an alternative embodiment of the present invention, also illustrated in FIG. 1, the straight ahead directional indicator can be activated by a completely separate activation means, such that lever 34 is comprised instead of an activation means 34a for the straight ahead directional indicator light, and an activation means 34b would activate the left and right directional turn signal lights.

The flasher 22 utilizes the 12-volt power source 18 of the vehicle's electrical system to heat up an internal bi-metallic strip. When the directional indicator is activated, power is sent to the flasher unit 22 to activate interior lights to inform the driver that his directional indicator has been activated, and exterior directional indicator lights 28, 30 and 32, for the benefit of other drivers and pedestrians.

The addition of the straight ahead directional indicator in accordance with the present invention is particularly advantageous for indicating to other drivers, particularly when stopped at an intersection, the stated intention of the driver to either turn or to continue straight. Referring to FIG. 4, a 4-way intersection 48 is shown, for the purpose of illustrating this particular advantage according to the present invention. Intersection 48 is a 4-way stop intersection, meaning that every vehicle approaching the intersection must stop at stop sign 50 before proceeding either right, left, or straight ahead. At any intersection, it is not only useful, but statistically safer, to know the directional intentions of the other drivers at the intersection. If two facing vehicles, 52 and 54 or 56 and 58, are both turning left, or both turning right, or both proceeding straight ahead, the two facing drivers can often leave the intersection simultaneously, keeping the flow of traffic constant.

Similarly, two perpendicular vehicles, for example 52 and 56, can also proceed simultaneously when both are turning right, or the vehicle 52 to the right is turning right and the other 56 is going straight ahead, or even if one is turning right and the other is turning left. Clearly, then, if each of the drivers of vehicles 52, 54, 56 and 58 all know the intentions of all of the other drivers at intersection 48, safety hazards and undesirable traffic flow problems can be reduced or eliminated. The addition of the straight ahead directional intention of a driver, in accordance with the teachings of the present invention, is an extremely manageable addition to any vehicle with the enormous payoff of improving driver safety and traffic flow.

Flowchart 60 of FIG. 5 illustrates a preferred embodiment of the present invention. As indicated by block 62, when a driver activates a signal indicator switch, the vehicle computer recognizes the activation in block 64. Specifically, the driver can push the signal lever down, as in block 66, to activate the left turn directional indicator lights in block 68; the driver can push the lever up, as in block 70, to activate the right turn directional indicator lights in block 72; or the driver can push the lever inward, as in block 74, to activate straight ahead directional indicator lights, as indicated in block 76.

The vehicle directional indicator means according to the present invention offers a number of advantages over the existing art. The present invention adds another valuable piece of information for drivers on the road as well as for pedestrians and bikers, to make vehicular travel safer and more efficient. The present invention accomplishes this by providing a vehicle directional indicator means that alerts others as to not only the left or right turn direction intentions of a driver, but also the straight ahead travel directional intention of a driver. This alerts both oncoming drivers and trailing drivers of the intention of other drivers on the road. Turn signals warn other drivers of impending moves to minimize hazards and abrupt actions; the addition of a straight ahead directional indicator will enhance the safety and knowledge of all persons using the roadways.

The foregoing discussion describes in detail a particular and preferred embodiment of the present invention, wherein the straight ahead signal indicator light is integrated into the existing left and right turn signal indicator means. It will be obvious to those skilled in the art that multiple embodiments are possible without departing from the scope and content of the present invention, specifically, the addition of a straight ahead signal indicator. For example, the straight ahead signal indicator means could be activated by a completely separate means than the left and right turn signal activation means. Activation of the straight ahead signal indicator means could be an independent switch or lever, not directly associated with the left and right turn signal means. Furthermore, the precise location of the ambient lights on the front and rear of the vehicle, indicating straight ahead travel, could be in a variety of locations, but are described as being approximately centered and horizontally lined up with the existing ambient left and right turn signal lights. It is also anticipated that the straight-ahead indicator lights will approximately match the color and size of the left and right indicator lights, but it will be obvious to those skilled in the art that any such visual preference or design does not depart from the scope of the invention described herein.

Having described the invention in detail and by reference to the preferred embodiment thereof, it will be apparent that other modifications and variations are possible without departing from the scope of the invention defined in the appended claims.

What is claimed is:

1. A vehicle directional indicator system for indicating the directional travel intentions of a driver of the vehicle, the system comprising:
an ignition system;
a turn signal circuit for receiving power when the ignition is keyed on;
a power source for transporting the power;
a thermal flasher for receiving the power from the power source;
a directional indicator means activated by a driver of the vehicle for indicating direction of intended travel.

2. A vehicle directional indicator system as claimed in claim 1 whereby the directional indicator means is associated with a steering column for the vehicle.

3. A vehicle directional indicator system as claimed in claim 2 whereby said directional indicator means is multi-positional.

4. A vehicle directional indicator system as claimed in claim 3 whereby depending on position applied to the multi-positional directional indicator means, power is sent to a left turn signal indicator light or a right turn signal light indicator light, or a straight ahead signal indicator light.

5. A vehicle directional indicator system as claimed in claim 1 whereby said signal indicator lights include indicator lights on an interior dashboard of the vehicle.

6. A vehicle directional indicator system as claimed in claim 1 whereby said signal indicator lights include indicator lights on said front and rear exteriors of the vehicle.

7. A vehicle directional indicator system as claimed in claim 1 whereby power flows through a filament of said signal indicator lights and is grounded.

8. A straight ahead directional indicator for a motor vehicle, comprising:
a motor vehicle having front and rear opposing ends, a left driver's side having a left turn signal light disposed thereon and a right side having a right turn signal light disposed thereon, wherein said left and right turn signal lights are disposed on said left and right sides of said front end and said rear end, said vehicle having a dashboard disposed therein;
straight ahead directional signal lights disposed on said front end centrally located between said left and right turn signal lights, and on said rear end centrally located between said left and right turn signal lights and inside of said vehicle conveniently located on said dashboard;
an activation means for said straight ahead directional signal lights being disposed interior to said motor vehicle to permit the straight ahead directional signal lights to be controlled by a driver of vehicle; and
means for supplying power to said straight ahead directional signal lights and said activation switch.

9. The straight ahead directional indicator of claim 8, wherein said means for supplying power to said straight ahead signal lights and said activation means comprises a battery to permit the motor vehicle straight ahead indicator signal lights and activation means to be powered.

10. A straight ahead directional indicator as claimed in claim 8 whereby said activation means is disposed on said dashboard.

11. A straight ahead directional indicator as claimed in claim 8 further comprising a steering column associated with said motor vehicle, whereby said activation means is associated with said steering column,

12. A straight ahead directional indicator as claimed in claim 8 whereby said straight ahead directional signal lights include signal lights on an interior dashboard of the vehicle.

13. A straight ahead directional indicator as claimed in claim 8 whereby power flows through a filament of said signal straight ahead directional signal lights and is grounded.
